(19) United States
(12) Patent Application Publication
(10) Pub. No.: US 2017/0052588 A1
(43) Pub. Date: Feb. 23, 2017

(54) ELECTRONIC DEVICE AND HANDS-FREE CONTROL METHOD OF ELECTRONIC DEVICE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: YU ZHANG, Shenzhen (CN); CHENG-CHING CHIEN, New Taipei (TW); JUN-JIN WEI, New Taipei (TW)

(21) Appl. No.: 14/933,565

(22) Filed: Nov. 5, 2015

(30) Foreign Application Priority Data
Aug. 18, 2015 (CN) 201510507497.0

(51) Int. Cl. G06F 3/01; G06F 3/00; H04N 5/33; G06F 3/16

(52) U.S. Cl. CPC G06F 3/013; G06F 3/167; G06F 3/005; H04N 5/33

(57) ABSTRACT

A hands-free control method for an electronic device requires a display device, a storage device, and a camera in the device. The method includes capturing an infrared image of a user's eye and a direction of gaze of a user's eye being analyzed according to the captured infrared image to determine a focus of the eye on the display device. Movements of the focus on the display device according to a previous position and a current position of the focus of the eye can be analyzed. A control instruction is generated according to a relationship between control instructions and eye movements and voice instructions can be generated based on received voice command from the user. The display device is controlled to perform predetermined actions when the voice instruction matches with the control instruction.

### CROSS-REFERENCE TO RELATED APPLICATIONS

This application claims priority to Chinese Patent Application No. 201510507497.0 filed on Aug. 18, 2015, the contents of which are entirely incorporated by reference herein.

### FIELD

The subject matter herein generally relates to user interface technology, and particularly to an electronic device and hands-free control method of the electronic device.

### BACKGROUND

Electronic devices are widely used. People control the electronic device by an interface of human-computer interaction, such as a keyboard, a mouse, and others.

But usage of the electronic device is limited when the abilities of a keyboard or mouse may not be enough.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device.

FIG. 2 illustrates a front view of the electronic device of FIG. 1.

FIG. 3 is a block diagram of function modules of a hands-free control system of the electronic device of FIG. 1.

FIG. 4 illustrates a diagrammatic view of a pupil-corneal reflection of the control method.

FIG. 5 is a diagrammatic view of a focus of a user's eye on a display device of the electronic device of FIG. 1.

FIG. 6 illustrates a flowchart of a hands-free control method using the electronic device of FIG. 1

FIG. 7 illustrates a flowchart of another embodiment of the hands-free control method using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

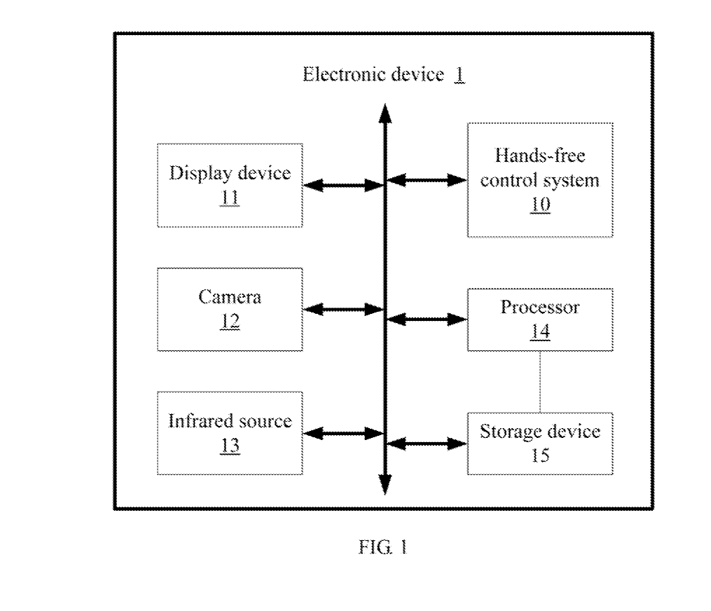

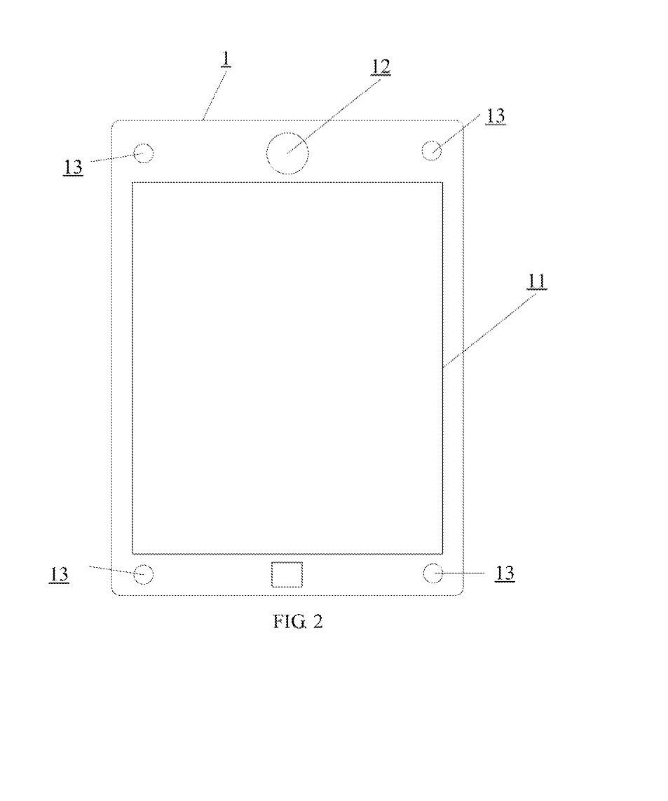

FIGS. 1-2 show an embodiment of an electronic device. In at least one embodiment shown in FIG. 1, an electronic device 1 can include, but is not limited to, a hands-free control system 10, a display device 11, a camera 12, at least one infrared source 13, at least one processor 14, and a storage device 15. The electronic device 1 can be a mobile phone, a tablet computer, a personal digital assistant, or any other electronic device having the display device 11. FIG. 1 illustrates only one example of the electronic device, other examples can include more or fewer components than illustrated, or have a different configuration of the various components in other embodiments.

In at least one embodiment, the display device 11 can display information. The information can include pictures, WebPages, documents, and any other subject which is capable of being displayed on the display device 11. The display device 11 can be in the front of the electronic device 1. In some embodiments, the display device 11 can display raster regions which have m rows and n lines, where m and n are positive integers.

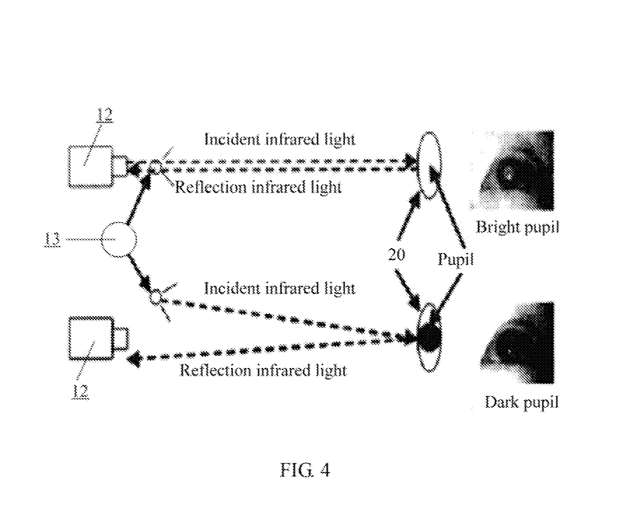

The camera 12 can be an infrared image capturing device. In at least one embodiment, the camera 12 can capture an infrared image of a user's eye 20 (shown in FIG. 4) when the user is viewing the display device 11. The camera 12 can be inbuilt into the electronic device 1, for example, the camera 12 can be located at the top of a frontal panel of the electronic device 1. The camera 12 also can be an external device connected to the electronic device 1 via a wireless connection (for example, a WIFI™ connection) or a cable (for example, a universal serial bus cable).

In at least one embodiment, the infrared source 13 can emit infrared light to the user's eye 20. The infrared source 13 can constantly emit infrared light to the user's eye 20 when the infrared source 13 is activated. In some embodiments, the infrared source 13 can be a Light Emitting Diode (LED). The infrared source 13 can facilitate capture of a clear infrared image of the user's eye 20 even under a condition of poor light because the user's eye 20 is not sensitive to the infrared light. As shown in FIG. 2, there are four infrared sources 13, and the four infrared sources 13 can be located at a frontal panel of the electronic device 1, for example, the top left, bottom left, top right, and bottom right, respectively.

In at least one embodiment, the processor 14 can be a central processing unit (CPU), a microprocessor, or other data processor chip that performs functions of the hands-free control system 10. The processor 14 is connected to the display device 11, the camera 12, the infrared source 13 and the storage device 15.

In at least one embodiment, the storage device 15 can include various types of non-transitory computer-readable storage mediums. For example, the storage device 15 can be an internal storage system, such as a flash memory, a random access memory (RAM) for temporary storage of messages, and/or a read-only memory (ROM) for permanent storage of messages. The storage device 15 can also be an external storage system, such as a hard disk, a storage card, or a data storage medium.

In some embodiments, the storage device 15 can store preset data. The preset data can include a relationship between control instructions and movements, and/or a relationship between link instructions and focus of an eye 20 on the display device 11. The movements can include moving up, moving down, moving right, and moving left. The control instructions corresponding to the movements can include controlling the information currently displayed on the display device 11 (hereinafter referred as to current information) to move up, controlling the current information displayed on the display device 11 to move down, controlling information previously (hereinafter referred as to previous information) which the current information replaces to display on the display device 11, and controlling information to replace the current information (hereinafter referred as to next information).

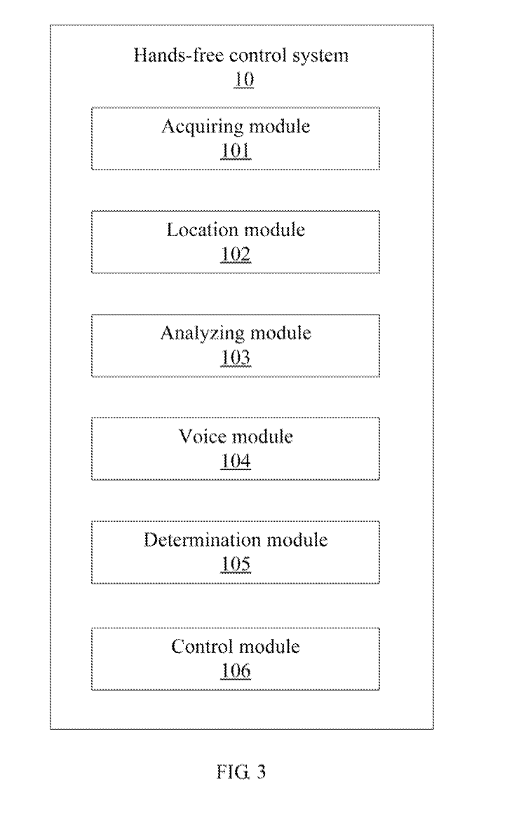

FIG. 3 shows function modules of the hands-free control system. In at least one embodiment, the hands-free control system 10 can include, but is not limited to, an acquiring module 101, a location module 102, an analyzing module 103, a voice module 104, a determination module 105, and a control module 106. The function modules 101-106 can include computerized codes in the form of one or more programs which are stored in the storage device 15. The at least one processor 14 executes the computerized codes to perform functions of the function modules 101-106.

The acquiring module 101 can activate the camera 12 to capture infrared images of the user's eye 20, when detecting an activation of the hands-free control system 10.

In some embodiments, the acquiring module 101 is connected to the camera 12 and the infrared source 13. The display device 11 can display an application icon in accordance with the hands-free control system 10. When the user touches the application icon, the hands-free control system 10 is activated. The acquiring module 101 starts the infrared source 13 to emit infrared light and activates the camera 12 to capture infrared images.

The location module 102 can analyze a direction of gaze of the user's eye 20 according to the captured infrared images, to determine a focus of the eye 20 on the display device 11.

In some embodiments, the location module 102 determines a focus of the eye 20 on the display device 11 by using a pupil-corneal reflection method. As shown in FIG. 4, when the infrared source 13 emits infrared light to the user's eye 20, then a surface of a cornea of the user's eye 20 generates a reflecting spot. Extracting location information of the pupil of the user's eye 20 in the infrared images is easy, because the pupils are the darkest parts in the infrared images. When the user's eye 20 moves, the center of the pupil and the reflecting spot on the surface of the corneal of the user's eye 20 move relative to each other. If the reflecting spot is used as a static reference point, a change of the position of the pupil can be deemed as the movement of the user's eye 20.

The analyzing module 103 can generate a control instruction according to the relationship between control instructions and movements stored in the storage device 15. The movement of the user's eye 20 on the display device 11 can be analyzed. Details of the analyzing of movement are not described here.

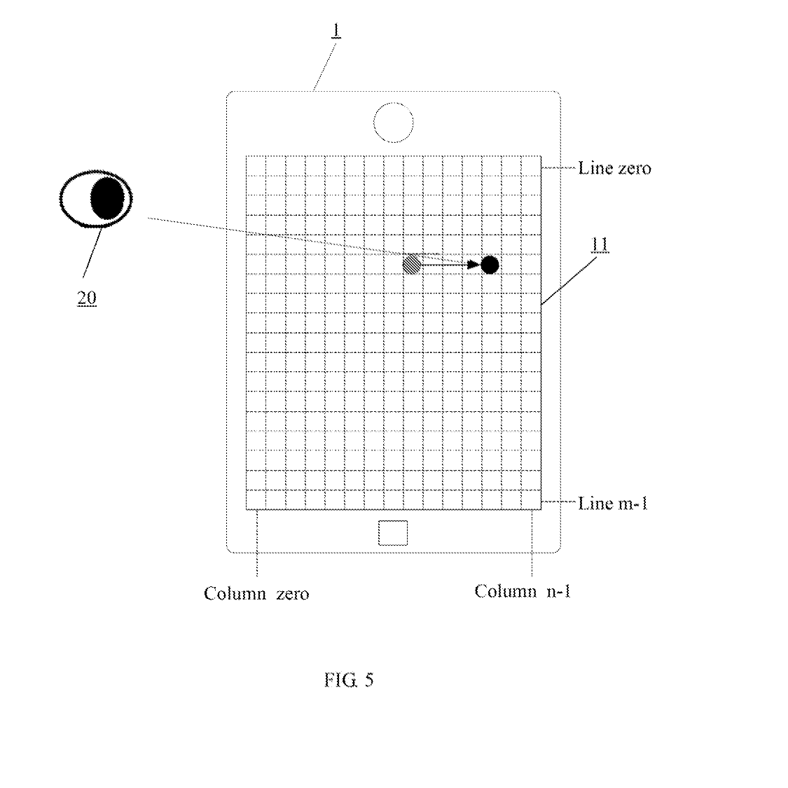

FIG. 5 shows focus of the eye 20 on a display device according to direction of gaze of the eye 20. For example, the display device 11 can display a raster region. If the previous focus of the eye 20 on the display device 11 was in row 5, column 5, and the current focus of the eye 20 on the display device 11 is in row 5, column 2, the analyzing module 103 can analyze that the user's eye 20 has moved left, and generate a control instruction to replace the current information with the previous information. If the previous focus of the eye 20 on the display device 11 was in row 6, column 5, and the current focus of the eye 20 on the display device 11 is in row 6, column 7, the analyzing module 103 can analyze that the user's eye 20 has moved right, and generate a control instruction to replace the current information with the next information.

In at least one embodiment, in order to allow for limitations of the user, the analyzing module 103 can ignore a deviation angle of the direction of gaze of the user within a predefined angle. That is to say, if the deviation angle of the direction of gaze of the user does not exceed the predetermined angle (e.g., 20 degrees), the analyzing module 103 can analyze the movement of the user's eye 20 without consideration of the deviation angle, that is to say, within a particular tolerance of 20 degrees.

The analyzing module 103 can also generate a link instruction according to a relationship between link instructions stored in the storage device 15 and the focus of the eye 20 on the display device 11, when the eye 20 is focusing on a link on the display device 11.

The voice module 104 can receive voice commands from the user and generate a voice instruction based on the received voice commands. For example, when the user say “next information”, the voice module 104 can generate an instruction to control the display device 11 to display next information.

The determination module 105 can firstly determine whether the voice instruction matches with the link instruction. If a determination is made that the voice instruction matches with the link instruction, the control module 106 can control the information linked to the link address to be displayed on the display device 11. If a determination is made that the voice instruction does not match with the link instruction, the determination module 105 can secondly determine whether the voice instruction matches with the control instruction.

If a determination is made that the voice instruction matches with the control instruction, the control module 106 can control the display device 11 to perform predetermined actions. The predetermined actions can include, for example, controlling the current information to move up, controlling the current information to move down, controlling the previous information to replace the current information, or controlling the next information to replace the current information. If a determination is made that the voice instruction does not match with the control instruction, the control module 106 can control the display device 11 to retain the display of current information.

The following are several exemplary embodiments about the usage of the hands-free control system 10.

In a first exemplary embodiment, the user can view pictures or documents, or other information, without a link. The analyzing module 103 analyzes the user's eye 20 as moving left, and then generates a control instruction to control previous information to be displayed on the display device 11. The voice module 104 generates a voice instruction to control next information to be displayed on the display device 11 after receiving a “next information” voice command from the user. The determination module 105 determines that the control instruction to control previous information to display does not match with the voice instruction to control next information to display on the display device 11. The control module 106 controls the display device 11 to display unchanged current information.

In a second exemplary embodiment, the user can view pictures or documents, or other information, without a link. The analyzing module 103 analyzes the user's eye 20 as moving right, and then generates a control instruction to control next information to display on the display device 11. The voice module 104 generates a voice instruction to control next information to display on the display device 11 after receiving a “next information” voice command from the user. The determination module 105 determines that the control instruction to control next information to display matches with the voice instruction to control next information to display on the display device 11. The control module 106 controls the display device 11 to display next information.

In a third exemplary embodiment, when the user is accessing the Internet, the display device 11 can display a plurality of links. The previous focus of the eye 20 on the display device 11 was in row 4, column 2 The analyzing module 103 generates a link instruction to link the “TV” information, referencing row 4, and column 2 If the user says “TV”, the voice module 104 can generate a voice instruction to control TV information to display on the display device 11. The determination module 105 determines that the link instruction to link “TV” information matches with the voice instruction to control TV information to display. The control module 106 controls the display device 11 to display the TV information. If the user says “music”, the voice module 104 can generate a voice instruction to control music to play by a loudspeaker of the electronic device 1. The determination module 105 determines that the link instruction to link “TV” information does not match with the voice instruction to control the music to play. The control module 106 controls the display device 11 to retain the display of current information.

That is to say, when the user is searching for the Internet, the analyzing module 103 firstly analyzes a link instruction in accordance with the focus of the eye 20.

If there is no link instruction in accordance with the focus of the eye 20, the analyzing module 103 secondly analyzes any movement of the focus of the user's eye 20. For example, if the previous focus of the eye 20 was in row 9, column 5, and the current focus of the eye 20 on the display device 11 is in row 1, column 5, the analyzing module 103 firstly determines there is no link instruction in accordance with the row 1, column 5 direction of gaze. Then, the analyzing module 103 secondly determines that the focus of the eye 20 is moving up, and generates a control instruction to control the current information displayed on the display device 11 to move up.

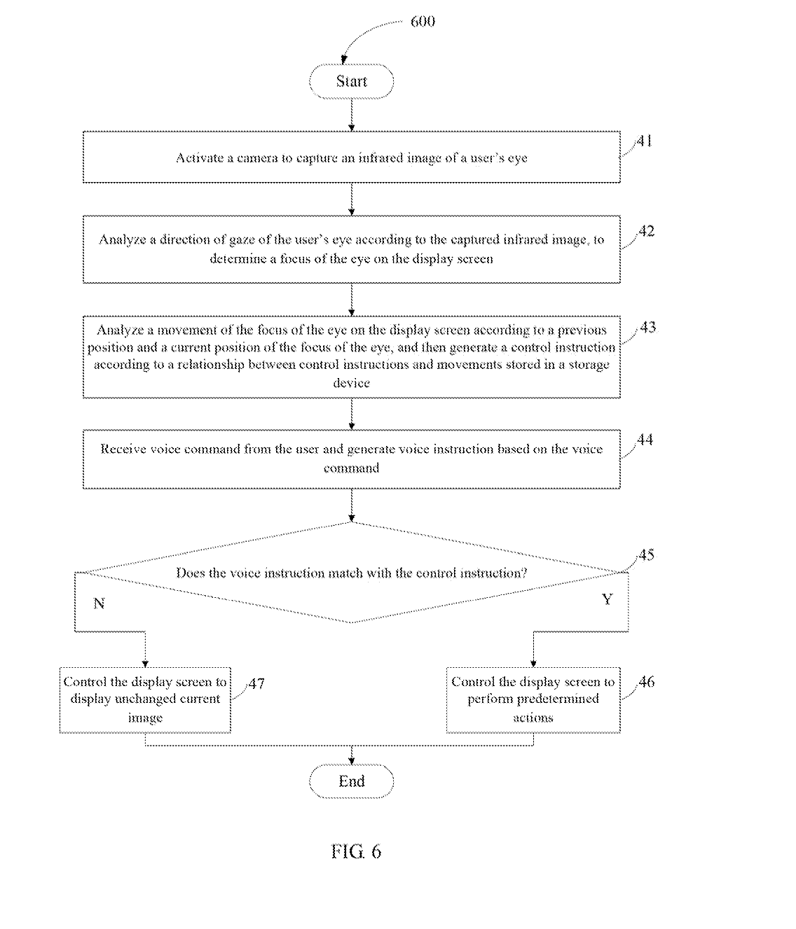

FIG. 6 illustrates a flowchart in accordance with an exemplary embodiment.

An exemplary method 600 is provided by way of example, as there are a variety of ways to carry out the method. The exemplary method 600 described below can be carried out using the configurations illustrated in FIG. 1 and FIG. 2, and various elements of these figures are referenced in explaining the example method. Each block shown in FIG. 6 represent one or more processes, methods, or subroutines carried out in the exemplary method 600. Furthermore, the illustrated order of blocks is illustrative only and the order of the blocks can be changed. The exemplary method 600 can begin at block 41. Depending on the embodiment, additional blocks can be utilized and the ordering of the blocks can be changed.

At block 41, an acquiring module activates the camera to capture an infrared image of the user's eye, when the hands-free control system is activated by the user.

At block 42, a location module analyzes the direction of gaze of the user's eye according to the captured infrared image, to determine a focus of the eye on the display device.

At block 43, an analyzing module analyzes a movement of the focus of the eye on the display device according to a previous position and a current position of the focus of the eye, and then generates a control instruction according to the relationship between control instructions and movements stored in the storage device.

At block 44, a voice module receives voice commands from the user and generates a voice instruction based on the received voice commands.

At block 45, a determination module determines whether the voice instruction matches with the control instruction. If the voice instruction matches with the control instruction, the process goes to block 46. If the voice instruction does not match with the control instruction, the process goes to block 47.

At block 46, a control module controls the display device to perform predetermined actions, for example, controls the current information displayed on the display device to move up, controls the current information to move down, controls the previous information to replace the current information, or controls the next information to replace the current information.

At block 47, a control module controls the display device to retain the display of current information.

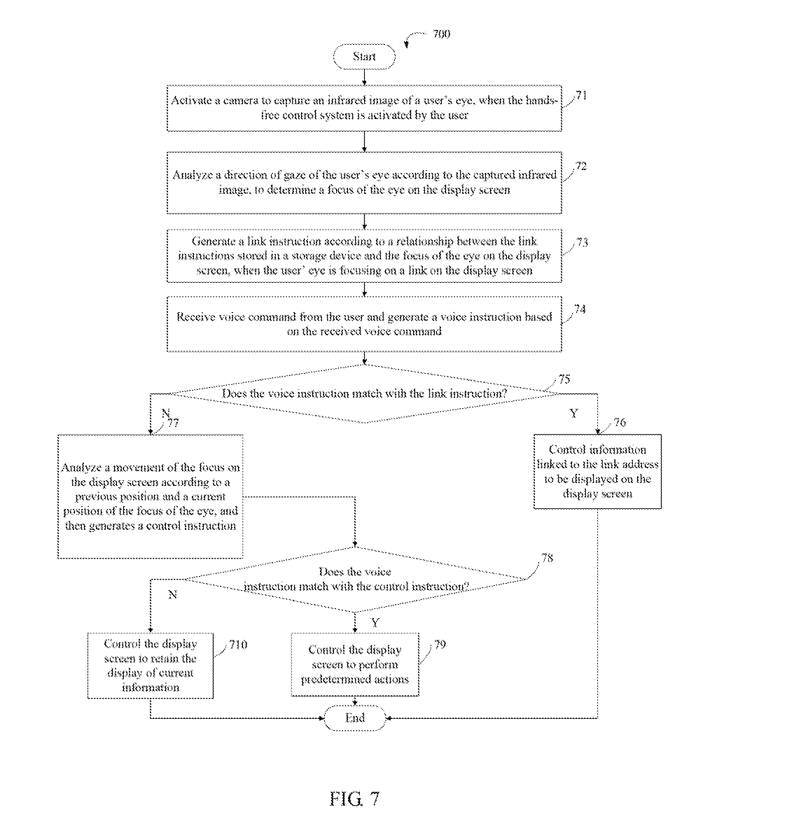

FIG. 7 illustrates a flowchart in accordance with another exemplary embodiment. An exemplary method 700 is provided by way of example, as there are a variety of ways to carry out the method. The exemplary method 700 described below can be carried out using the configurations illustrated in FIG. 1 and FIG. 2, and various elements of these figures are referenced in explaining the exemplary method. Each block shown in FIG. 7 represent one or more processes, methods, or subroutines carried out in the exemplary method 700. Furthermore, the illustrated order of blocks is illustrative only and the order of the blocks can be changed. The exemplary method 700 can begin at block 71. Depending on the embodiment, additional blocks can be utilized and the ordering of the blocks can be changed. The method 700 can be executed by an electronic device having a camera.

At block 71, an acquiring module activates the camera to capture an infrared image of the user's eye, when the hands-free control system is activated by the user.

At block 72, a location module analyzes the direction of gaze of the user's eye according to the captured infrared image, to determine a focus of the eye on the display device.

At block 73, an analyzing module generates a link instruction according to the relationship between the link instructions stored in the storage device and the focus of the eye on the display device, when the user' eye is focusing on a link on the display device.

At block 74, a voice module receives voice command from the user and generates a voice instruction based on the received voice command

At block 75, a determination module determines whether the voice instruction matches with the link instruction. If a determination is made that the voice instruction matches with the link instruction, the process goes to block 76. If a determination is made that the voice instruction does not match with the link instruction, the process goes to block 77.

At block 76, a control module controls information linked to the link address to be displayed on the display device.

At block 77, the analyzing module further analyzes a movement of the focus of the eye on the display device according to a previous position and a current position of the focus of the eye, and then generates a control instruction according to the relationship between control instructions and movements stored in the storage device.

At block 78, the determination module determines whether the voice instruction matches with the control instruction. If the voice instruction matches with the control instruction, the process goes to block 79. If the voice instruction does not match with the control instruction, the process goes to block 710.

At block 79, the control module controls the display device to perform the predetermined actions, for example, controls the current information displayed on the display device to move up, controls the current information to move down, controls the previous information to replace the current information, or controls next information to replace the current information.

At block 710, the control module controls the display device to retain the display of current information.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

1. A computer-implemented hands-free control method being executed by at least one processor of an electronic device, the electronic device comprising a display device, a storage device, and a camera, the method comprising:
activating the camera to capture an infrared image of a user's eye when detecting an activation of a hands-free control system;
analyzing, by the at least one processor, a direction of gaze of the user's eye according to the captured infrared image, and determining a focus of the eye on the display device;
analyzing, by the at least one processor, a movement of the focus of the eye on the display device according to a previous position and a current position of the focus of the eye, wherein the analyzing of the movement of the focus of the eye comprises ignoring a deviation angle of the direction of gaze of the eye when the deviation angle of the direction of gaze is within a predefined angle;
generating, by the at least one processor, a control instruction according to a relationship between control instructions and movements stored in the storage device;
receiving, by the at least one processor, voice command from the user;
generating a voice instruction based on the received voice command; and
controlling, by the at least one processor, the display device to perform predetermined actions when the voice instruction matches with the control instruction.

2. The method according to claim 1, further comprising:
controlling, by the at least one processor, the display device to display unchanged current information when the voice instruction does not match with the control instruction.

3. The method according to claim 1, wherein the movement of the focus of the eye on the display device comprises: moving up, moving down, moving left, and moving right.

4. The method according to claim 1, wherein the predetermined action comprises controlling current information displayed on the display device to move up, controlling the current information to move down, controlling previous information to replace the current information, or controlling next information to replace the current information.

5. The method according to claim 1, wherein the display device displays current information which comprises links, the method further comprises:
generating a link instruction according to a relationship between the link instructions stored in the storage device and the focus of the eye on the display device when the eye is focusing on a link on the display device.

6. The method according to claim 5, further comprising:
controlling information linked to a link address to be displayed on the display device when the voice instruction matches with the link instruction.

7. An electronic device comprising:
a display device;
a camera;
at least one processor coupled to the display device and the camera; and
a storage device coupled to the at least one processor and storing one or more programs executable by the at least one processor to cause the at least one processor to:
activate the camera to capture an infrared image of a user's eye when detecting an activation of a hands-free control system;
analyze, by the at least one processor, a direction of gaze of a user's eye according to the captured infrared image, and determine a focus of the eye on the display device; analyze, by the at least one processor, a movement of the focus of the eye on the display device according to a previous position and a current position of the focus of the eye, wherein the analyzing of the movement of the focus of the eye comprises ignoring a deviation angle of the direction of gaze of the eye when the deviation angle of the direction of gaze is within a predefined angle;
generate, by the at least one processor, a control instruction according to a relationship between control instructions and movements stored in the storage device;
receive, by the at least one processor, voice command from the user;
generate a voice instruction based on the received voice command; and
control, by the at least one processor, the display device to perform predetermined actions when the voice instruction matches with the control instruction.

8. The electronic device according to claim 7, further comprising:
when the voice instruction does not match with the control instruction, controlling the display device to display unchanged current information.

9. The electronic device according to claim 7, wherein the movement of the focus of the eye on the display device comprises: moving up, moving down, moving left, and moving right.

10. The electronic device according to claim 7, wherein the predetermined action comprises controlling current information displayed on the display device to move up, controlling the current information to move down, controlling previous information to replace the current information, or controlling next information to replace the current information.

11. The electronic device according to claim 7, wherein the display device displays current information which comprises links, the method further comprises:
generating a link instruction according to a relationship between the link instructions stored in the storage device and the focus of the eye on the display device when the eye is focusing on a link on the display device.

12. The electronic device according to claim 11, further comprising:
controlling information linked to a link address to be displayed on the display device when the voice instruction matches with the link instruction.

13. A non-transitory storage medium having stored thereon instructions that, when executed by a processor of an electronic device, causes the processor to perform a controlling method using the electronic device, the method comprising:
activating the camera to capture an infrared image of a user's eye when detecting an activation of a hands-free control system;
analyzing, by the at least one processor, a direction of gaze of the user's eye according to the captured infrared image, and determining a focus of the eye on the display device;
analyzing, by the at least one processor, a movement of the focus of the eye on the display device according to a previous position and a current position of the focus of the eye, wherein the analyzing of the movement of the focus of the eye comprises ignoring a deviation angle of the direction of gaze of the eye when the deviation angle of the direction of gaze is within a predefined angle;
generating, by the at least one processor, a control instruction according to a relationship between control instructions and movements stored in the storage device;
receiving, by the at least one processor, voice command from the user;
generating a voice instruction based on the received voice command; and
controlling, by the at least one processor, the display device to perform predetermined actions when the voice instruction matches with the control instruction.

14. The non-transitory storage medium according to claim 13, further comprising:
when the voice instruction does not match with the control instruction, controlling, by the at least one processor, the display device to display unchanged current information.

15. The non-transitory storage medium according to claim 13, wherein the movement of the focus of the eye on the display device comprises: moving up, moving down, moving left and moving right.

16. The non-transitory storage medium according to claim 13, wherein the predetermined action comprises controlling current information displayed on the display device to move up, controlling the current information to move down, controlling previous information to replace the current information, or controlling next information to replace the current information.

17. The non-transitory storage medium according to claim 13, wherein the display device displays current information which comprises links, the method further comprises:
generating a link instruction according to a relationship between the link instructions stored in the storage device and the focus of the eye on the display device when the eye is focusing on a link on the display device.

18. The non-transitory storage medium according to claim 17, further comprising:
controlling information linked to a link address to be displayed on the display device when the voice instruction matches with the link instruction.

19. The method according to claim 1, further comprising:
activating four infrared sources located at a frontal panel of the electronic device to emit infrared light to the eye, wherein the infrared image is captured based on the infrared light emitted by the four infrared sources.

20. The electronic device according to claim 7, wherein the at least one processor is further caused to:
activate four infrared sources located at a frontal panel of the electronic device to emit infrared light to the eye, wherein the infrared image is captured based on the infrared light emitted by the four infrared sources.
